(19) United States
(12) Patent Application Publication
(10) Pub. No.: US 2008/0259818 A1
(43) Pub. Date: Oct. 23, 2008

(54) HOME-TO-HOME DELIVERY OF MEDIA CONTENT VIA CABLE

(76) Inventor: Edward BALASSANIAN, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 11/933,147

(22) Filed: Oct. 31, 2007

Related U.S. Application Data
(63) Continuation of application No. 10/861,584, filed on Jun. 4, 2004.
Application No. 10/861,584 is a continuation of application No. 10/636,296, filed on Aug. 6, 2003, now abandoned.
(60) Provisional application No. 60/401,905, filed on Aug. 7, 2002.

(51) Int. Cl. H04L 12/28

(52) U.S. Cl. 370/254

(57) ABSTRACT

A residential services gateway operating within a networked home setting that is enabled by a Strings software program to obtain, view, and/or repurpose content obtained from within the networked home setting or exterior of the networked home setting.

### CROSS REFERENCES TO RELATED APPLICATIONS

This application is a continuation of and incorporates by reference in its entirety to U.S. patent application Ser. No. 10/861,584 filed Jun. 4, 2004 titled Home-To-Home Delivery of Media Content Via Cable, which is a continuation of U.S. patent application Ser. No. 10/636,296 filed Aug. 6, 2003 which claims the benefit of U.S. Provisional Patent Application No. 60/401,905 filed Aug. 7, 2002. All application herein incorporated by reference in their entirety.

### FIELD OF THE INVENTION

A Networked Home Demonstration System available 30 Jul. 2002 from BeComm Corporation is described.

### SUMMARY OF THE INVENTION

A networked home demonstration system having a digital, networked and open structure is described. The networked home demonstration system is described in terms of Equipment; a Network Diagram; a System Overview comprising a Home Network user interface (UI); and Devices in home and other usage scenarios available under pricing and schedules provided by BeComm Consulting Services. The equipment, devices, and services of the Networked Home Demonstration System available from BeComm Corporation Jul. 30, 2002 include a port-to-axis camera, MPEG4 optimizations, head end and home network UT setup.

The purpose of this document is to provide an overview of a networked home based on Strings. This document can also serve as a high-level specification for a lab trial to evaluate the potential of using of Strings in a networked home.

While the focus of this demonstration system is the use of Strings on a RSG platform, a variety of other Strings enable devices have also been included with the intention of demonstrating the full potential of Strings in a networked home.

It should be noted that all the hardware outlined in this document is readily available today. The only software requirement beyond the standard operating system software included with the various devices is BeComm's Network Application Platform, Strings. Strings is available as a royalty-free runtime and can be quickly installed on a wide variety of devices ranging from network cameras to handheld devices and desktop PCs.

In summary, the goals of this document are to demonstrate the power of a Strings enabled residential services gateway (RSG) in a networked home setting; Demonstrate the interaction of an RSG platform with a head-end and digital-TV platform; and demonstrate the interaction of Strings enabled devices in the home.

Based on this information, we hope to show how quickly, cost effectively and simply the company enable a residential services gateway platform and more generally, the fully networked home.

### BRIEF DESCRIPTION OF THE DRAWINGS

FIG. 1 illustrates a network Diagram of a home network system.

### DETAILED DESCRIPTION OF THE PARTICULAR EMBODIMENTS

Equipment Overview

The majority of the equipment required for building this demonstration system is readily available from manufacturers or retain stores. The RSG and the head-end server are simulated with a standard desktop PC.

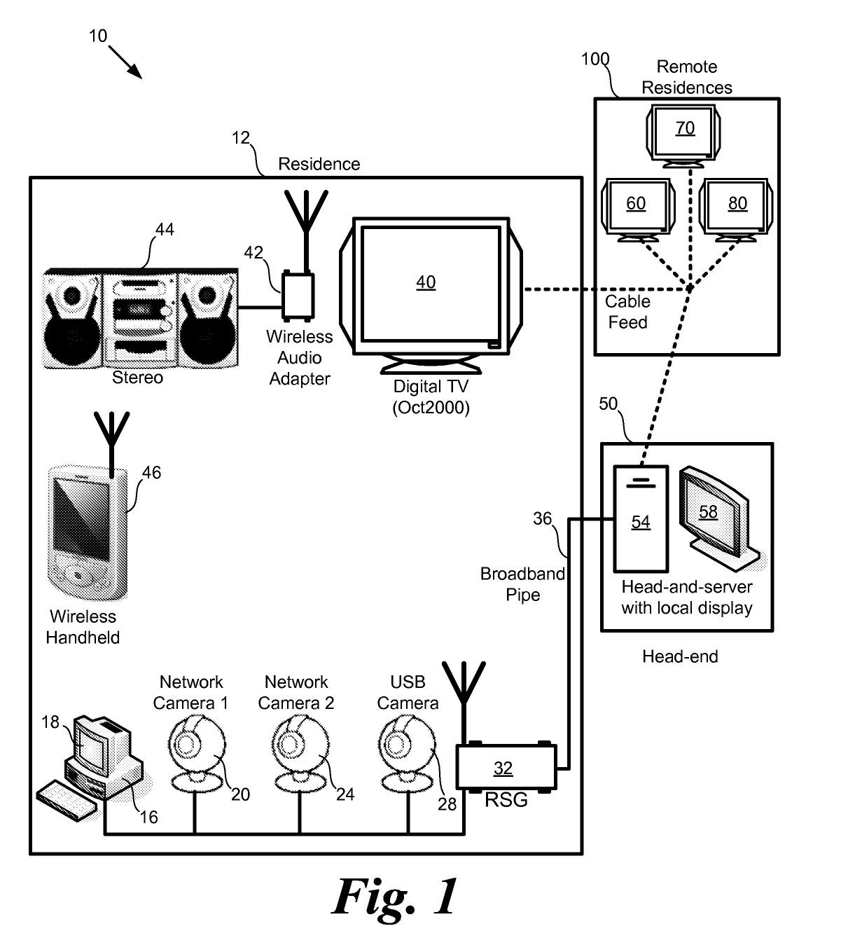

FIG. 1 illustrates a network diagram of a home network system 10. The home network system 10 includes a residence 12, a head-end server 50, and a set of remote residences 100. The residence 12 includes equipment descriptions as follows: a desktop personal computer (PC) 16 having a monitor 18, the PC 16 is fitted with 64 megabytes (Mb) random access memory (RAM), an Ethernet card, and includes a 800 MHz Pentium (PITT) processor running a Windows 2000 operating system. Other equipment includes a first Network Camera 20 and a second network camera 24. The first network camera 20 and the second network camera 24 may also be designated as network camera-1 and network camera-2. The first and second network cameras 20/24 may include cameras available from Panasonic and in an alternate embodiment, Axis Communications Inc., Boston, Chelmsford, Mass. USA. The Axis camera is recommended since it runs Linux, and Strings that can be loaded directly onto the camera.

Other camera equipment includes a USB Camera 28. In alternate embodiments, the USB camera 28 may be a USB version 1.0 cameras may be more readily available. In alternate embodiments, the USB camera 28 may include a version USB 2.0. In general, the USB 2.0 cameras have higher bandwidth capability and thus better image quality. The USB 1.0 and 2.0 cameras may be obtained from Logitech, Inc., Fremont, Calif., USA.

Shown in signal communication with the desktop PC 16, the first/second cameras 20/24, and the USB camera 28 is a residential services gateway 32. The RSG 32 may be a Windows 2000 PC equipped similarly to the Desktop PC except it will have two network cards; one for the local area network (LAN) connection in the home and one for the wide area network (WAN) connection. In other particular embodiments, the RSG 32 platform may be xscale based and configured with Intel hardware.

The residence 12 also includes a digital TV (Oct2000), a wireless audio adapter 42 connected with a stereo 44, and a wireless handheld computing device 46. The wireless handheld computing device 46 for purposes of this demo, these devices can be simulated with a handheld device such as an iPaq with 802.11b wireless capability or similar Windows CE/PocketPC based handheld device. Any wireless device with a web browser will be able to interact with the home network 10. The wireless audio adapters 42 consist of a processor, network connection and audio output. Strings manages the interaction of these devices with the network 10. Particular embodiments of the wireless handheld computing device 46 and wireless audio adapter 42 may utilize DEMS and OOMS configurations. The stereo 44 can be any off-the-shelf system with audio input jacks. It will be connected to the home network 10 via the wireless audio adapter 42.

Via cable feed or cable connection 48, The digital TV 40 may be in communication with other digital televisions 60, 70, and 80 located of the remote residences 100. The wireless audio adapter 42 and the wireless handheld computing device 46 are in signal communication with the RSG 32. Via broadband pipe 36, the Head-End Server 50 is in communication with the RSG 32. The head-end server 50 includes a computer server 54 similarly equipped as the Desktop PC 16 and is connected with a local-monitor 58. The UI from the head-end server 50 will be displayed on the local-monitor 58. In actual deployment this UT will be converted into an MPEG2 stream and displayed on the end users digital television 40. MPEG conversion is beyond the scope of this document.

The head-end server 50, via the cable feed 48, is also in communication with the digital television 40 of the residence 12 and with the digital televisions 60, 70, 80 of the remote residences 100. With regard to the OCT2000 Equipped TV 40 of the residence 12, the UT from the head-end server 50 will be displayed on the local monitor 58 so that the UT appearance on the TV 40 is not necessary but included it in the FIG. 1 diagram for completeness. Given that the head-end server 50 is also connected to digital TVs 60, 70, 80 in other residences 100, content from one home can be routed to the other residences 100. This is detailed at more length later in this document discussed under Digital Communities below.

System overview. Appearing on the monitor 18 and/or the local monitor 58 is a home network UI. The home Network UT will allow the user to engage in three activities: browse for devices and content, connect devices and content together to form dataflows, and control devices and dataflows.

With regards to browsing, the UT permits a user to browse for available devices such as network cameras 20, 24, stereos 44, handheld 46, or the desktop PC 16. Note that the TV 40, and optionally the TVs 60,70, 80 of other residences 100 in the user's community would also be listed as a device. The UT also allows a user to browse for available content such as music files, movie files, and photos. The UT may also allow the user to browse for active dataflows of content. For example, an existing playlist being played on a stereo 44, a security camera streaming video to the PC 16, or a photo playlist being rendered on the TV 40.

With regards to connecting, the UT allows a user to connect to devices having video content from security cameras to one or more display capable devices such as the TV 40, desktop PC 18, or wireless handhelds 46. The users can also connect a camera to multiple end points such as the TV 40 for viewing and simultaneously, the PC 18 for recording. The UT allows the user to connect music content with the music capable device, e.g., to connect music from the PC 16 with the wireless stereo 44. The UT also may allow the user to connect photo content with the display capable devices such as the television set 40 or the wireless handheld 46. The UT may also allow the user to connect movie content such as stored movies on the PC 16 to the wireless handheld 46 or to other PC located in other residences 100.

With regards to controlling, the UT allows a user to control devices in the network 10. For example, users can turn device on or off, control the volume of the music playout on the stereo 44, or till and pan a network camera 20, 24. The UT may also control active dataflows, including stopping a dataflow, pausing a dataflow, controlling devices in a dataflow, or adding new devices to an existing dataflow. Further descriptions of the devices of the home network 12 of system 10 encompass that the digital TV 40 with Oct2000, being connected to the head end sever 50, allows users to be able to tune to a special “home network” channel to interact with their home network 10. The UT that is presented will be created by the head-end server 50 and converted into an MPEG2 stream at the head end 50. It is assumed that the Oct2000 digital TV 40 will provide a back channel to the head end server 50 for limited control inputs from an IR remote. The MPEG2 rendering and the control feedback have not been included in this specification. It is assumed that the local display 58 for the head-end server 50 can be used to render the UT and for control input.

Other device embodiments provide alternatives to ITV and alternative methods. The alternative methods include sending control signals to the head end 50 that do not require an ITV-enabled set top box. A telephone based control system would allow the home user to call into an application running on the head-end server 50 that would interpret OTMF tones as control signals enabling the user's phone to serve as a remote control for the home-network channel. Another option is to use the wireless handheld device 46, such as a personal data assistant (PDA), to communicate with software on the head-end server 50 via the broadband Internet connection 36. The head-end server 50 will also be able to interact with the RSG 32 via the broadband pipe 36 to stream video camera 20, 24, 28 dataflows, photos and music from the home network 12 through the head-end 50 and to the TV 40. Using the above mentioned alternate control schemes would remove the requirement of an ITV enabled set to box. All that would be necessary is an addressable set top box.

Other TV-based activities include direct video camera feeds to the TV 40, desktop PC 16, or wireless handheld 46. Other TV-based activities include direct and control music playback from the PC 16 or Internet to the TV 40, or wireless stereo 44 or wireless handheld 46. Other activities include direct and control photo rendering from the PC 16 or Internet to the TV 40, or PC 16 or wireless handheld 46. Yet other activities include direct and control movie playback from the PC 16 or Internet to the PC 15 or wireless handheld 46.

The desktop PC 16 has a large display 18 and abundant processing power so that the user can utilize the desktop 16 for complex interactions with the home network 12. All the activities available on the TV 40 would be available on the PC 16, including accessing the content stored on the PC 16. The content stored on the PC 16 include photos, music and movies. Uses of the desktop PC 16 include automatically seeing the content in the home network UI. If more than one PC 16 exists in the network 10, the content is automatically aggregated giving the user a single virtual library of content. The abundant disk space of the PC 16 can also be sued to store real-time streams captured form the security camera 28. The UI allows users to se and/or hear this content or any of the devices they choose. In addition to running the home network UI on the PC 16, the PC 16 also is the natural place to create playlists and manage content. Many applications exist for this purpose and it is assumed users will use their favorite.

The wireless handheld 46 is an ideal device for controlling, interacting with, and consuming content. The entire home network 10 UI functionality would be available on the handheld 46 with slight modifications due to the limited screen size. Note that if the user directs content such as video from a network camera 20,24 to be rendered on the handheld 46, Stings will dynamically adjust bandwidth for the resultant dataflow so the handheld 46 can consume the content.

The stereo 44 with wireless adapter 42 allow a traditional stereo to become a network addressable device. The adapter 42 consists of a wireless Ethernet card, a processor, memory and audio output. When Strings enabled, this stereo 44 with wireless adapter 42 is discoverable in the home network 12 and can be sued to playback audio content from other sources such as files on the PC 16 or radio content form the Internet. In alternate embodiments, BeComm may provide DEMs and ODMs for retailing in Q4 of 2002. The network cameras 20,24 are based on an embedded processor design with on board Ethernet and memory. Strings enables the cameras 20,24 to be discoverable, controllable, and can be made connectable to other devices for video rendering. An example of this Strings enablement would be in a scenario in which the screen of TV 40 is used view feeds from the camera 20,24 for viewing or for recording on the PC 16 disk drive. Another example would be using the wireless handheld 46 to stream video from the security camera 28 to the screen of the handheld device 46 and the TV 40 screen simultaneously. The USB camera 28 acts exactly like a network camera 20, 24 except that it is attached directly to the RSG 32 or optionally the desktop PC 16. Several USB 1.9 and 2.0 enabled cameras are available.

The RSG 32 will serve as a gateway to the home network 10 namespace. This will allow the head-end server to run the home network UI. Since the RSG also manages the broadband connection to the Internet, it will serve as a NAT and firewall. Since Strings is readily available on both embedded and desktop platforms, the RSG 32 could be replaced by a PC 16 running Strings.

The Head-end server 50 will interact with the RSG 32 to facilitate generation of the home network 10 UT which will subsequently be sent to the digital TV 40. For purposes of this demo, we have not addressed to process of converting the screen UT from the head-end server to an mpeg2 stream. Because the head-end server is connected with the RSG, the head-end is able to have full control over the home network. This include being able to browse, control and connect as outlined above.

Other usage scenarios for the systems and method described above include content/device interactivity, remote network interaction, and establishment of digital communities. With regard to content/device interactivity, the RSG 32 and the head-end 50 when connected, make it feasible to have the regular broadcast content fed through the head-end 50 to take advantage of the knowledge of certain devices within the home. With regard to remote network interaction, the utilization of Strings on the RSG 32 makes it possible to access device content with the home from locations outside the home network 12. This would, for example, enable checking of security cameras 28 from central offices. With regard to digital communities, the head-end server 50 receives content from the RSG 32 and typically will overlay this onto the home network UT and send it via MPEG2 to the home set-top-box. This would allow, for example, a home user to send a live video stream or photo playlist to another user's house. Strings is an ideal platform for peer-to-peer applications such as this. The company can use this functionality to enable users to create personal communities of friends and family. Users of the system would be able to share photos, live streams of video and other types of content with members of their community. To view photos or other content, users would only need to be a subscriber with the digital TV 40. The RSG 32 would not be required in the viewing home. Furthermore, the role of the RSG 32 can be provided by the home PC 16 with a broadband connection making the deployment of this solution entirely software based.

Yet other usage scenarios for the systems and method described above include dynamic content repurposing, automated consent management, automated playback and distribution configured for plasma screens, and content reaction tools. Dynamic content repurposing provides for an intelligent infrastructure for the dissemination and rendering of video content in theaters with the primary focus geared to leverage existing technology, both applications and hardware, to render video content suitable for theater presentation without the costly burden associated with content repurposing. This usage scenario is directed on the technology within the theater, and does not address the process required to get content from the content-creators to the theater itself. Strings may be utilized to effect the process of delivery content from the content creators to the theater in that Strings provides intelligent plumbing that will dynamically repurpose movies, adds, and other video content to each PC in the theater (Strings runs on the popular Windows platform so this is a simple install). The parameters associated with each screen will be programmed into the corresponding PC. This will enable Stings to repurpose content for a given screen based on the dimensions of the screen. This includes cropping, scaling, etc. No modifications will be made to the actual programs that are used to play back the content. Strings can apply its transformation before these applications touch the content.

Automated consent management minimizes the need for human interaction in the playback of content and also minimizes the infrastructure costs associated with the playback of content. Automated playback and distribution configured for plasma screens allows PCs to be replaced with a video relay that allows for each screen 40 to be networked to a central server 50, as illustrated in FIG. 1 for the home network located in residence 12 and other TVs 60, 70, and 80 located in remote residences 100. The relay will be running Strings as will the server 50. This will allow the server 50 to dynamically repurpose content based on the parameters for the screens 40, 60, 70, 80 that have been input into the relay. In addition, because Strings is on the relay, all aspects of the relay including playback of video content will be controllable from the server 50. This means it is realistic for a single operator to manage playback of content across dozens of screens in a theater—all from a central command/control post.

Implementation may occur in phases including establishing automated playback and distribution undertaken in a movie screen embodiment, establishing automated playback and distribution in a plasma screen embodiment, establishment of content creation tools, and making available content creation tools to content creators. With regard to the movie screen embodiment involving playback and distribution, the PCs 16 may be replaced with a video relay that will allow for each screen 40 to be networked to the central server 54 of the Head-end 50. The relay may run Strings as will the server 54. This configuration allows the server 54 to dynamically repurpose content based on the parameters for the screen 40 that have been inputted into the relay. In addition, because Strings is on the relay, all aspects of the relay including playback of video content will be controllable from the server 54. This means it is realistic for a single operator to manage playback of content across dozens of screens in a theater, all from a central command/control post.

Referring to establishing automated playback and distribution in a plasma screen embodiment, video relays may be added to existing plasma screens 40, 60, 70, and 80 so they can be driven off the same server 54 as the movie screens. This arrangement allows all plasma screens 40, 60, 70, 80 to be managed in a similar fashion to the movie screens, thereby reducing human capital costs as well as infrastructure costs since there will be one content management system for all display devices in the theater.

Referring to the establishment of content creation tools, each of the relay's will be dynamically discoverable by the central server 54 so new screens can be added at any time. The tools provide for remote administration of the screen including playback management tools and remote diagnostic/monitoring tools. Strings provides all the necessary platform support for remote control, distributed playback and content repurposing. In addition to providing video relays to interface with legacy systems, Strings may be incorporated by manufacturers of projectors and plasma screens.

Referring to making available content creation tools to content creators, advertisers primarily, the content creation tools allows the meta tagging of content created for theaters. The meta tags will include information about how to display content for different types of audiences, display devices, and environments. This allows the content creators to specify “hints” about their content that end systems will use to render content optimally.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for providing a home network user interface, comprising:
means for browsing for devices and content;
means for connecting content and devices from data flows; and
means for controlling devices and data flows.
